(19) United States
(12) Patent Application Publication
(10) Pub. No.: US 2011/0197502 A1
(43) Pub. Date: Aug. 18, 2011

(54) STACKABLE PLANT SUPPORT DEVICE

(76) Inventor: ROBERT MORRIS, Mexico, NY (US)

(21) Appl. No.: 13/028,217

(22) Filed: Feb. 15, 2011

Related U.S. Application Data
(60) Provisional application No. 61/304,714, filed on Feb. 15, 2010.

(51) Int. Cl. A01G 9/12

(52) U.S. Cl. 47/39

(57) ABSTRACT

A stackable plant support device includes a square open top frame and four collapsible staked legs. The four legs each extend downwardly from a corner of the square open top frame. When the legs rest upon the ground, the square open top frame and the legs will encompass a growing plant.

### CROSS-REFERENCE TO RELATED APPLICATION

This application claims the benefit of Provisional Patent Application No. 61/304,714, filed on Feb. 15, 2010, in the United States Patent & Trademark Office, the disclosure of which is incorporated herein by reference.

### BACKGROUND OF THE INVENTION

1. Field of the Invention

The present invention relates to a growing plant enclosure, and more particularly, a stackable plant support device.

The stackable plant support device folds up for easy storage. The present invention also has a square open top frame with a removable side portion that allows installation on plants that are already established or have grown beyond the height of one support device.

The stackable plant support device can be used in gardens to support vegetable plants, within deck pots and also landscaped plants of multiple sizes requiring support. The present invention provides the unique feature of being stacked to varying heights to form tiers and connecting the tiers together for added stability. The support device is foldable for easy, neat, compact storage and the removable side portion prevents plant damage when added to mature plants.

2. Description of the Prior Art

Any gardener who grows climbing plants must find a way to keep the plants off of the ground. Many use steel cages, which can easily bend or rust. They also have rings tack-welded to the legs, which are prone to breaking, rendering the cage useless. Due to the poor quality of these metal cages, most cages still need to be staked or tied to prevent them from falling over. A more efficient way is needed.

Numerous innovations for planter structures have been provided in the prior art that will be described. Even though these innovations may be suitable for the specific individual purposes to which they address, however, they differ from the present invention.

A FIRST EXAMPLE, U.S. Pat. No. 3,113,400, Issued on Dec. 10, 1963, to Emond teaches a plant support, comprising a pair of elongate rectangular frames adapted to be vertically positioned in use and each of which frames embodies a pair of relatively rigid spaced parallel side rods and a plurality of transverse connecting rods positioned across the side rods, the connecting rods of each frame being in spaced parallel relation in the longitudinal direction of the side rods and each of the connecting rods being rigidly secured adjacent its ends to the adjacent side rods, two of the transverse connecting rods of each frame adjacent to the top of the frame being in relatively closely spaced relation as compared to the spacing of the remaining transverse connecting rods, the side rods having portions extending at the lower ends of the frames beyond the lowermost transverse connecting rods to provide ground penetrating means, a plurality of pivot rods spaced longitudinally of and connecting the side rods of one of the frames with corresponding side rods of the other frame by pivot eyes at the ends of the pivot rods having the side rods extending loosely therethrough, the uppermost ones of the pivot rods connecting adjacent side rods of the two frames having the pivot eyes at the ends thereof lying between the adjacent two of the closely spaced transverse top rods and being restrained thereby against movement longitudinally of the side rods but being free to turn thereon, and the other spaced pivot rods having the pivot eyes thereof positioned above and resting upon underlying transverse connecting rods and being free to have both turning movement about the side rods and sliding movement on and longitudinally of the side rods in the space between adjacent transverse connecting rods.

A SECOND EXAMPLE, U.S. Pat. No. 4,073,091, Issued on Feb. 14, 1978, to Vogel teaches a foldable plant support comprising a first frame and a second opposed frame, each frame having vertical legs with support members on the legs for receiving support bars that span the vertical legs of each frame and support bars that span the distance between the first frame and the second frame. The support bars that span the distance between the first frame and the second frame are hingedly secured to the first frame and the second frame through eyelets at the ends of the support bars, the eyelets having an opening sufficiently wide in diameter so that when the frame is folded over on itself, the various support bars can move with respect to the first and second frame without bending.

A THIRD EXAMPLE, U.S. Pat. No. 4,285,163, Issued on Aug. 25, 1981, to Booker Jr. teaches a four sided collapsible plant enclosure for supporting and maintaining growing plants safe from rodents and other intruders. The structure described includes four sides, each side being hinged to an adjacent side. The hinged sides permit collapsing of the structure for storage. Two adjacent sides of the structure are selected to have a width less than the remaining two adjacent sides of the structure, thereby permitting the enclosure to be collapsed for efficient and safe storage.

A FOURTH EXAMPLE, U.S. Pat. No. 5,331,764, Issued on Jul. 26, 1994, to Sun teaches a rack for growing plants including a collapsible open frame having wire holes, through which a cord is inserted to set up a netting stretched in the collapsible open frame, and upright supports to support the collapsible open frame, each upright support having a forked top end terminated to a downward hook hooked in a hole on either corner on the collapsible open frame and an upward angle bar to support the collapsible open frame at either corner.

A FIFTH EXAMPLE, U.S. Pat. No. 5,640,802, Issued on Jun. 24, 1997, to Elliott teaches a support assembly for growing tomato plants which allows ready access to the plant during the various stages of growth by utilizing interchangeable parts including post sections having a tapered member on a bottom end and a tapered socket on the other end for joining the sections to form continuous posts having vertically spaced seating locations, and horizontal supports having sockets which fit securely onto post sections and spaced vertically to form modules that may be stacked in vertical relation and thereby added progressively to meet the needs engendered by growth of the plant and to permit ready access to the plant.

A SIXTH EXAMPLE, U.S. Pat. No. 6,088,956, Issued on Jul. 18, 2000, to Rocka teaches a foldable plant support system which provides a structure within which a plant may be grown and physically supported, and over which a protective cover may be drawn to provide a protective environment for a plant contained within the structure, and an irrigation system. The system may be used as a “hotcap” or “mini greenhouse” with the support structure and cover providing a protective environment for a seedling, new plant or the like. As the plant matures or as the weather dictates, the cover may be removed. The plant support structure has two or more vertical members and number of cross members connected to each other by a rotatable connector assembly which provide the foldable feature of the structure. A vertical member typically is rod-like and extends the entire height of the structure and has attachment points where it is attached to a connector assembly. The vertical member also includes a staking structure, which is used to anchor the plant support structure in place when in use. Loop shaped cross members are connected to and extend laterally from the vertical members, and each has attachment points for attaching the cross member to a connector assembly. The connector assembly provides a rotatable or pivotable attachment means for rotatable connecting a vertical member to a cross member. An exemplary connector is a hub and an axle assembly, with the hub having a passage for closely receiving and retaining one end of the axle.

A SEVENTH EXAMPLE, U.S. Patent Office Publication No. 2002/0104261, Published on Aug. 8, 2002, to Schulman et al. teaches a collapsible plant support structure which provides a structure wherein a plant may be grown and properly supported. The collapsible plant support structure has three or more vertical members connected to a plurality of rings by guide hubs on the vertical members, thusly providing the collapsible feature of the structure. A vertical member typically is rod-like and extends the entire length of the structure and has connection points set equidistant along the vertical members. The vertical members also include a tapered and angled staking structure to assist in strengthening the structure. The vertical members also have geometrically shaped footplates to assist in placing the structure into any given terrain.

AN EIGHTH EXAMPLE, U.S. Patent Office Publication No. 2006/0070298, Published on Apr. 6, 2006, to Palsrok teaches a plant stand which includes a plant holder box having side walls, end walls, and a bottom that combine to form an up-facing first pocket for supporting plants and dirt, and that combine to form a down-facing shallow pocket. The plant stand further includes folding legs attached to the plant holder box that are movable between a raised position where the legs are located within the shallow pocket and a lowered use position where the legs support the holder box above a ground surface. The plant stand also includes a first detent arrangement for holding the legs in the raised position against the bottom of the holder box and a second detent arrangement for holding the legs in the lowered use position.

A NINTH EXAMPLE, U.S. Patent Publication No. 2008/0263949, Published on Oct. 30, 2008, to Early teaches a plant growing kit, primarily for growing climbing plants such as tomatoes, that is contained in a flat box approximately the shape of a pizza box. In preferred embodiments three legs are included, broken down into sections in the box and directable into a sturdy tripod, over which a flexible vine-attachment element, such as a wire or thin tubular member or plastic coil, is assembled preferably in a tapered helical configuration. Also in the box is a basket, in flattened condition but erectable into a deep configuration and with provision for attachment to the legs, near their bottom ends, the basket being configured to contain a bag of soil, which may remain in the bag. The consumer provides drainage holes in the bag and an opening at top for the plants to grow and to climb up on the tripod and vine-attachment element. With a water-catching saucer under the bag and basket, the directed plant growing assembly can be placed in any desired location, including inside a building.

It is apparent now that numerous innovations for planter structures have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a stackable plant support device that avoids the disadvantages of the prior art.

ANOTHER OBJECT of the present invention is to provide a stackable plant support device that is simple and inexpensive to manufacture.

STILL ANOTHER OBJECT of the present invention is to provide a stackable plant support device that is simple to use.

BRIEFLY STATED, STILL YET ANOTHER OBJECT of the present invention is to provide a stackable plant support device which comprises a square open top frame. Four legs each extend downwardly from a corner of the square open top frame. When the legs rest upon the ground the square open top frame and the legs will encompass a growing plant.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention in an open position;

FIG. 2 is a perspective view of the present invention in a folded position;

FIG. 3 is a perspective view showing the present invention formed in a tier configuration about a growing plant inserted into the ground;

FIG. 4 is a perspective view showing the present invention formed into a multiple tier configuration inserted into the ground; and

FIG. 5 is a perspective view showing the present invention formed in a multiple tiered configuration per se.

### REFERENCE NUMERALS UTILIZED IN THE DRAWING

110 stackable plant support device
112 square open top frame of support device 110
114 leg of support device 110
116 ground
118 growing plant
120 socket of square open top frame 112
122 upper surface of square open top frame 112
124 tier of support devices 110
126 pointed tip on leg 114
128 hinge of square open top frame 112
130 front portion of square open top frame 112
132 rear portion of square open top frame 112
134 bottom surface of square open top frame 112
136 stack of support device 110
137 upper aperture in stack 136
138 connector of support device 110
140 removable side portion of square open top frame 112
142 high strength green colored plastic material of support device 110
144 galvanized rod of hinge 128
146 storage bag

### DETAILED DESCRIPTION OF THE PREFERRED EMBODIMENT

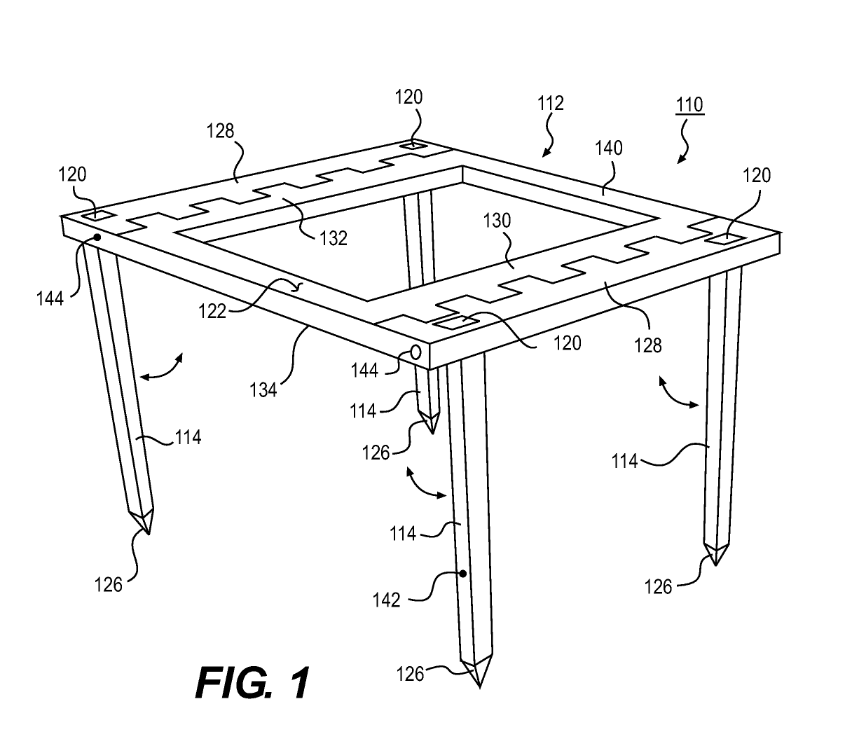

Referring now to the figures, in which like numerals indicate like parts, and particularly to FIGS. 1 through 5, and as such, will be discussed with reference thereto.

In FIG. 1: a stackable plant support device 110 which comprises a square open top frame 112. Four legs 114 are provided with each extending downwardly from a corner of the square open top frame 112. When the legs 114 rest upon the ground 116 the square open top frame 112 and the legs 114 will encompass a growing plant 118.

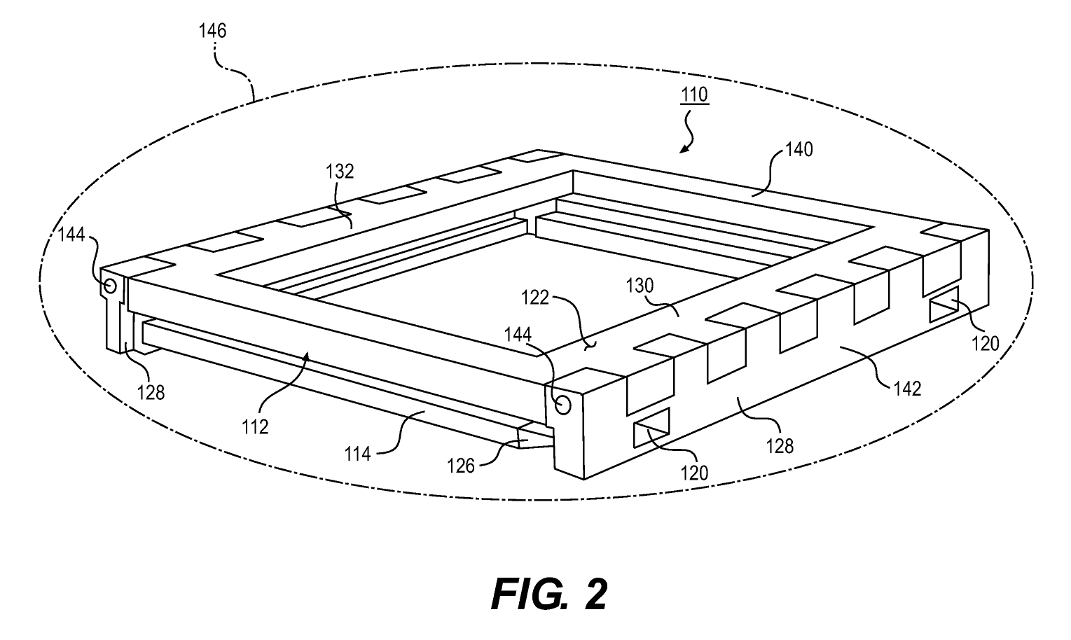

In FIG. 2: The square open top frame 112 comprises four sockets 120, each located in a corner of an upper surface 122 to receive the four legs 114 from the support device 110 directly above, whereby a plurality of support devices 110 can be stacked one upon another to form a tier 124. Each leg 114 further comprises a pointed tip 126 formed on a lower end thereof to help properly align with one socket 120 in the upper surface 122 of the square open top frame 112. The square open top frame 112 further comprises two hinges 128 each formed on front and rear portions 130, 132 of the square open top frame 112. Each hinge 128 retains two of the legs 114, so that the legs 114 can be folded inwardly against a bottom surface 134 of the square open top frame 112 for storage when not in use.

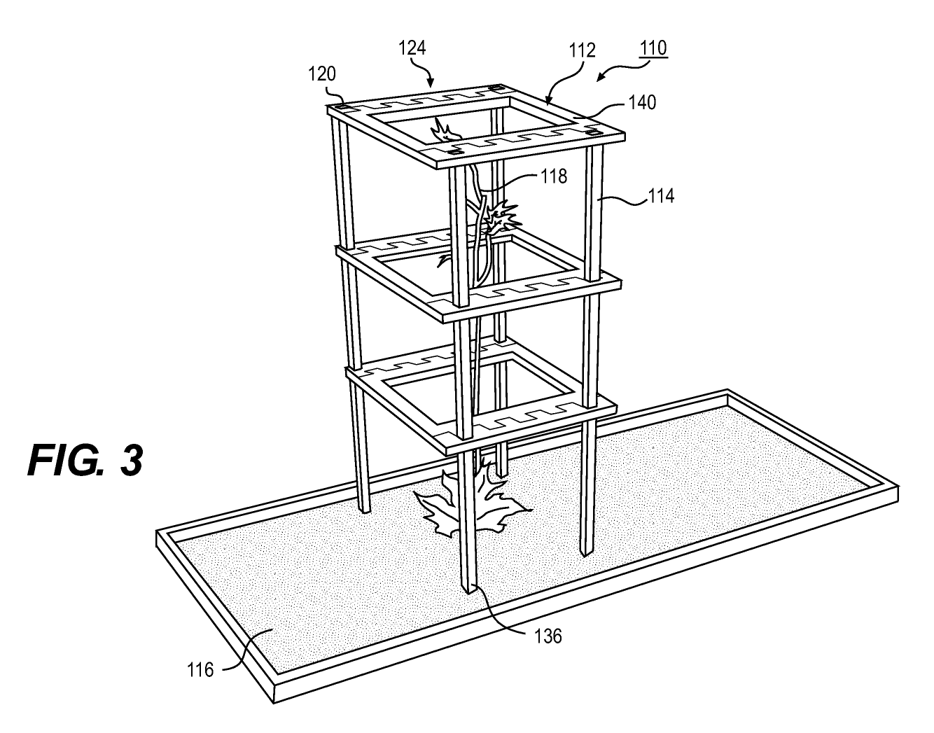

In FIG. 3: The support device 110 further comprises four stakes 136, each having an upper aperture 137 to fit over the pointed tip 126 of one leg 114, whereby the four stakes 136 can be inserted into the ground 116 about the growing plant 118 for additional stability. The support device 110 further comprises a plurality of connectors 138, whereby the connectors 138 can extend between multiple tiers 124 of the support devices 110 to further stabilize the tiers 124. The square open top frame 112 comprises at least one removable side portion 140 to allow for installation on a mature growing plant 118 without causing damage to the mature growing plant 118, because the square open top frame 112 can be placed from the side instead of from the top of the mature growing plant 118, especially when installing multiple tiers 124 of the support devices 110.

The square open top frame 112, the legs 114, the stakes 136 and the connectors 138 are fabricated out of a high strength green colored plastic material 142. Each hinge 128 comprises a galvanized rod 144 to add strength thereto. The square open top frame 112 is approximately sixteen inches by sixteen inches. Each leg 114 is approximately fourteen inches in length, so that when folded the support device 110 will be approximately two inches thick. Each stake 136 is approximately ten inches long.

A storage bag 146 may be included to hold the support device 110 for convenient storage.

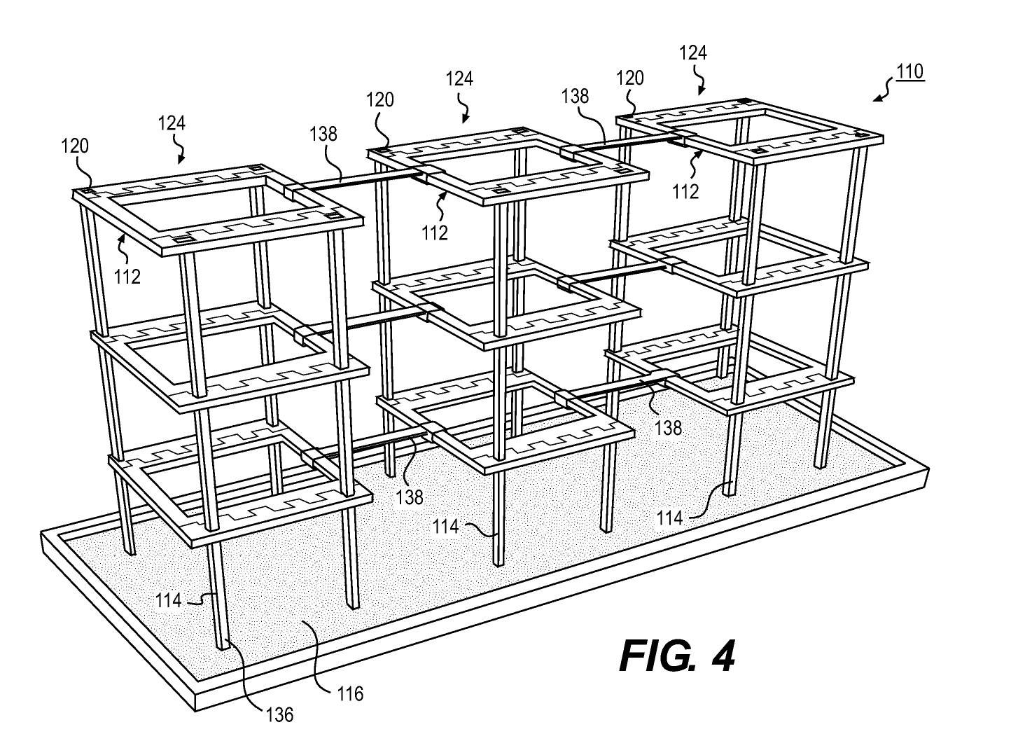

In FIG. 4: The present invention works by first attaching the stakes 136 to the legs 114 of the bottom support device 110 and drive them into the ground 118. Then the user may stack additional support devices 110 as needed on top of one another to form tiers 124.

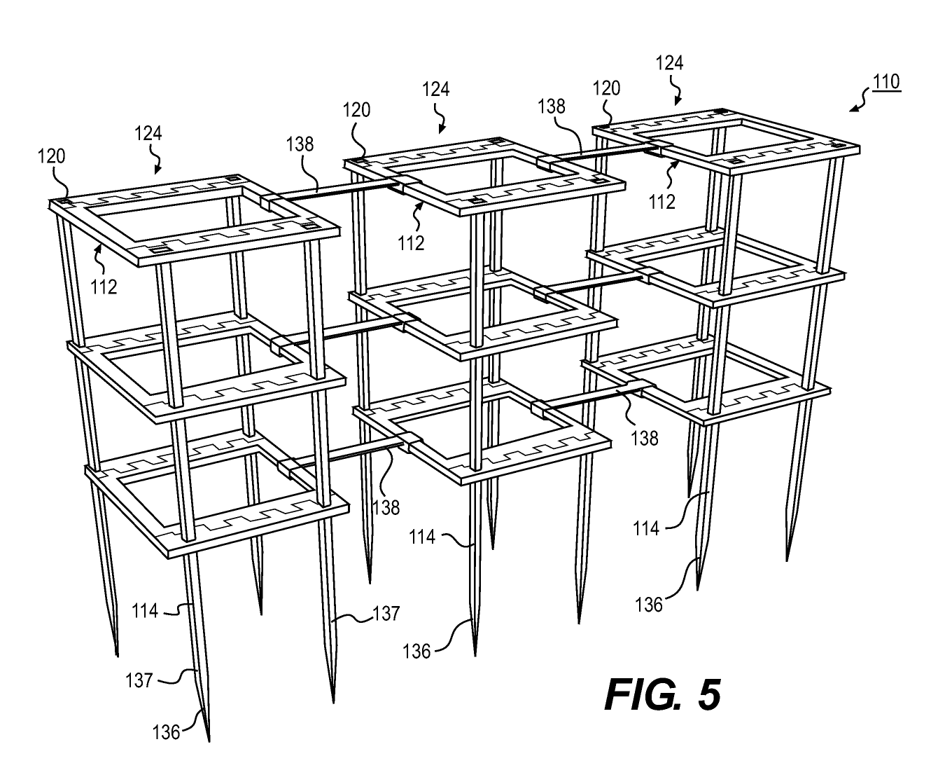

In FIG. 5: The support devices 110 of tiers 124 may be stabilized using the connectors 138. The length of the connectors 138 can be adjusted to accommodate the distance between the tiers 124. The components of the support devices 110 may all be folded and placed in the storage bag 146 until they are needed again. The exact specifications of the present invention may vary.

It will be understood that each of the elements described above, or two or more together, may also find a useful application in other types of constructions differing from the types described above.

While the invention has been illustrated and described as embodiments of a stackable plant support device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A stackable plant support device which comprises:
a) a square open top frame; and
b) four legs each extending downwardly from a corner of the square open top frame, whereby when the legs rest upon the ground the square open top frame and the legs will encompass a growing plant.

2. The support device as recited in claim 1, wherein the square open top frame comprises four sockets, each located in a corner of an upper surface to receive the four legs from the support device directly above, whereby a plurality of support devices can be stacked one upon another to form a tier.

3. The support device as recited in claim 2, wherein each leg further comprises a pointed tip formed on a lower end thereof to help properly align with one socket in the upper surface of the square open top frame.

4. The support device as recited in claim 3, wherein the square open top frame further comprises two hinges each formed on front and rear portions of the square open top frame, each hinge retains two of the legs, so that the legs can be folded inwardly against a bottom surface of the square open top frame for storage when not in use.

5. The support device as recited in claim 4, further comprises four stakes, each having an upper aperture to fit over the pointed tip of one leg, whereby the four stakes can be inserted into the ground about the growing plant for additional stability.

6. The support device as recited in claim 5, further comprises a plurality of connectors, whereby the connectors can extend between multiple tiers of the support devices to further stabilize the tiers.

7. The support device as recited in claim 6, wherein the square open top frame comprises at least one removable side portion to allow for installation on a mature growing plant without causing damage to the mature growing plant, because the square open top frame can be placed from the side instead of from the top of the mature growing plant, especially when installing multiple tiers of the support devices.

8. The support device as recited in claim 7, wherein the square open top frame, the legs, the stakes and the connectors are fabricated out of a high strength green colored plastic material.

9. The support device as recited in claim 8, wherein each hinge comprises a galvanized rod to add strength thereto.

10. The support device as recited in claim 9, wherein the square open top frame is approximately sixteen inches by sixteen inches, each leg is approximately fourteen inches in length, so that when folded the support device will be approximately two inches thick and each stake is approximately ten inches long.
